(19) United States
(12) Patent Application Publication
(10) Pub. No.: US 2025/0364737 A1
(43) Pub. Date: Nov. 27, 2025

(54) Terminal Connection Structure

(71) Applicant: Yazaki Corporation, Tokyo (JP)

(72) Inventors: Noboru Hayasaka, Makinohara-shi (JP); Kenshiro Shigemoto, Makinohara-shi (JP); Hiroshi Shinba, Fujieda-shi (JP)

(21) Appl. No.: 19/184,666

(22) Filed: Apr. 21, 2025

(30) Foreign Application Priority Data
May 22, 2024 (JP) 2024-083407

(51) Int. Cl. H01R 4/34; H01R 4/30

(52) U.S. Cl. CPC H01R 4/34; H01R 4/307

(57) ABSTRACT

A terminal connection structure includes: a first connector including a first terminal; a second connector including a second terminal; and a fastener configured to fasten the first terminal and the second terminal. The first connector includes a first opening configured to expose a first contact portion of the first terminal, and a protruding portion protruding toward the second connector. The second connector includes a second opening configured to expose a second contact portion of the second terminal and an inserted portion of the second terminal. The fastener fastens the first terminal and the second terminal in a state in which the first connector and the second connector are fitted to each other, in which the protruding portion is inserted into the inserted portion, and in which the first contact portion and the second contact portion are in contact with each other.

### CROSS-REFERENCE TO RELATED APPLICATION(S)

This application is based upon and claims the benefit of priority from prior Japanese patent application No. 2024-083407 filed on May 22, 2024, the entire contents of which are incorporated herein by reference.

### BACKGROUND

### 1. Field of the Invention

The present disclosure relates to a terminal connection structure including a first connector that includes a first terminal, a second connector that includes a second terminal electrically connected to the first terminal, and a fastener that fastens the first terminal and the second terminal.

### 2. Description of the Related Art

In the related art, a connection structure has been proposed in which a pair of terminals are electrically connected by being fastened with a bolt or the like (for example, see JP2021-089890A).

In the connection structure in the related art described above, in order to prevent an operator from accidentally touching a terminal (a so-called live part) to which a voltage is applied, it is essential to sandwich a tubular relay metal fitting between the terminals. Specifically, in the connection structure in the related art, the pair of terminals and the relay metal fitting are collectively fastened with a bolt and a nut in a state in which the relay metal fitting is sandwiched between the pair of terminals, thereby electrically connecting the pair of terminals. However, since the relay terminal is required, in the connection structure in the related art, it is difficult to reduce the thickness and size of the connection structure.

### SUMMARY

An object of the present disclosure is to provide a terminal connection structure that can be reduced in thickness and size while preventing erroneous touch by an operator.

In order to achieve the object described above, the terminal connection structure according to the present disclosure is characterized as follows.

According to an aspect of the present disclosure, there is provided a terminal connection structure including: a first connector including a first terminal; a second connector including a second terminal electrically connected to the first terminal; and a fastener configured to fasten the first terminal and the second terminal, in which the first terminal and the second terminal are electrically connected to each other, in which the first connector includes a first opening configured to expose a first contact portion of the first terminal, and a protruding portion protruding toward the second connector, in which the second connector includes a second opening configured to expose a second contact portion of the second terminal and an inserted portion of the second terminal, the inserted portion having a shape into which the protruding portion is to be inserted, and in which the fastener fastens the first terminal and the second terminal in a state in which the first connector and the second connector are fitted to each other, in which the protruding portion is inserted into the inserted portion, and in which the first contact portion and the second contact portion are in contact with each other.

According to the terminal connection structure in the present disclosure, when the first connector and the second connector are fitted to each other, the first terminal and the second terminal are fastened and electrically connected by the fastener in a state in which the protruding portion of the first connector is inserted into the inserted portion of the second terminal and the first contact portion of the first terminal and the second contact portion of the second terminal are in contact with each other. That is, the first terminal and the second terminal are connected without requiring a relay terminal or the like as in the connection structure in the related art. Further, the first terminal is accommodated in the first connector such that the first contact portion of the first terminal is exposed from the first opening, so that it is possible to prevent an operator from coming into contact with a portion other than the first contact portion. Therefore, the terminal connection structure having the present configuration can be reduced in thickness and size while preventing erroneous touch by an operator.

The present disclosure has been briefly described above. Further, the details of the present disclosure will be clarified by reading modes for carrying out the invention to be described below with reference to the accompanying drawings.

### BRIEF DESCRIPTION OF THE DRAWINGS

The present disclosure will become more fully understood from the detailed description given hereinbelow and the accompanying drawing which is given by way of illustration only, and thus is not limitative of the present disclosure and wherein:

FIG. 1 is a perspective view of a terminal connection structure according to an embodiment of the present disclosure;

FIG. 2 is an exploded perspective view of the terminal connection structure shown in FIG. 1;

FIG. 3 is a perspective view of a first connector shown in FIG. 2 as viewed obliquely from below;

FIG. 4 is a front view of the terminal connection structure shown in FIG. 1;

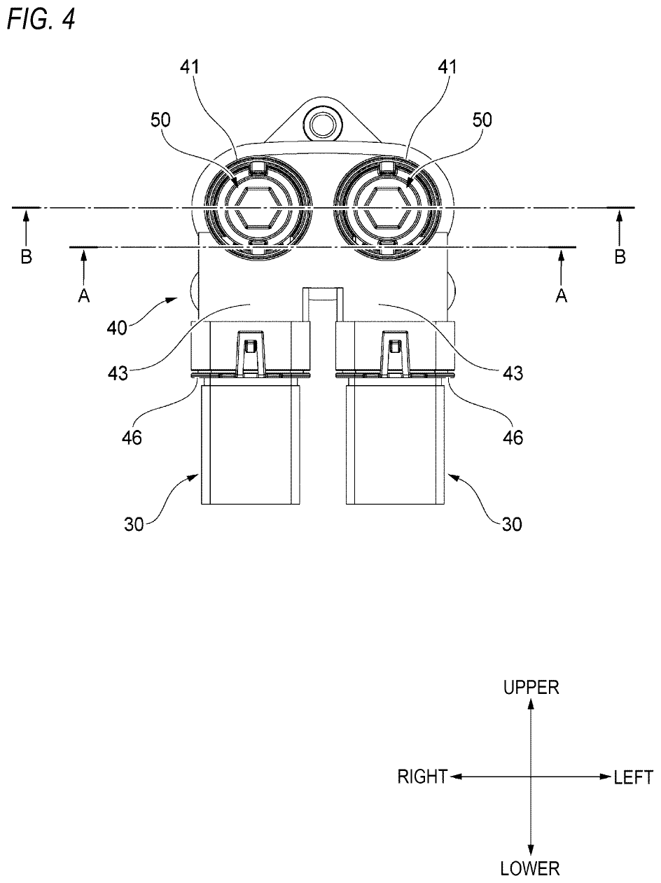

FIG. 5 is a cross-sectional view taken along a line A-A in FIG. 4; and

FIG. 6 is a cross-sectional view taken along a line B-B in FIG. 4.

### DETAILED DESCRIPTION OF THE INVENTION

### Embodiment

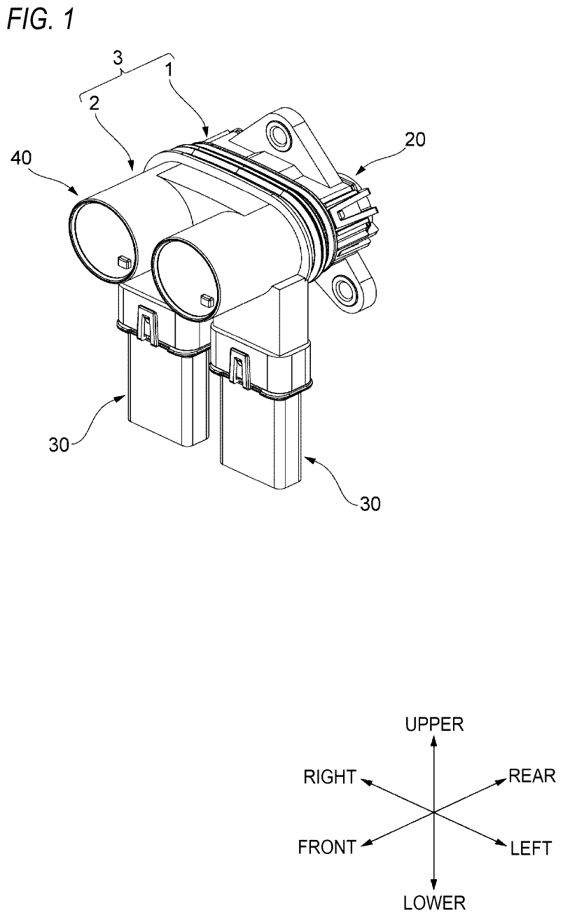

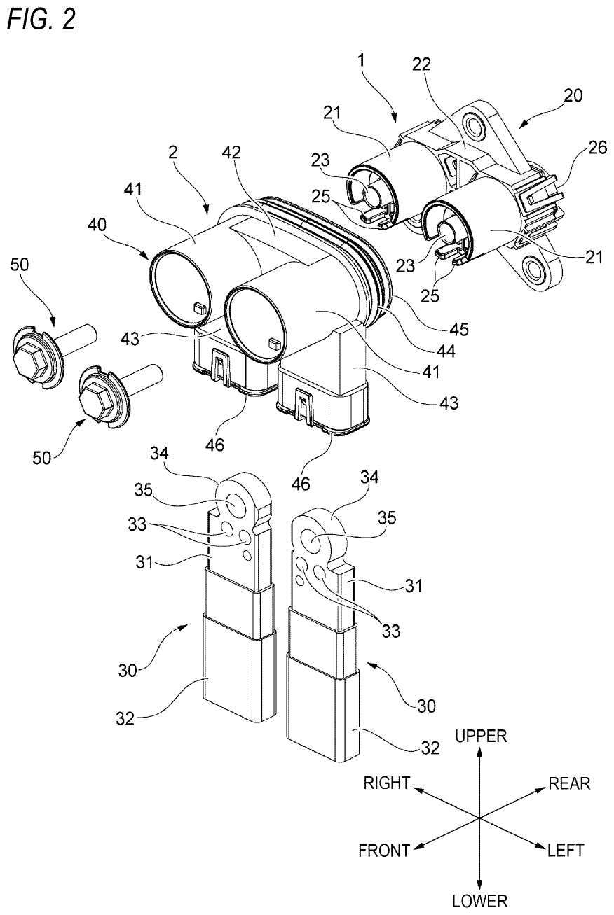

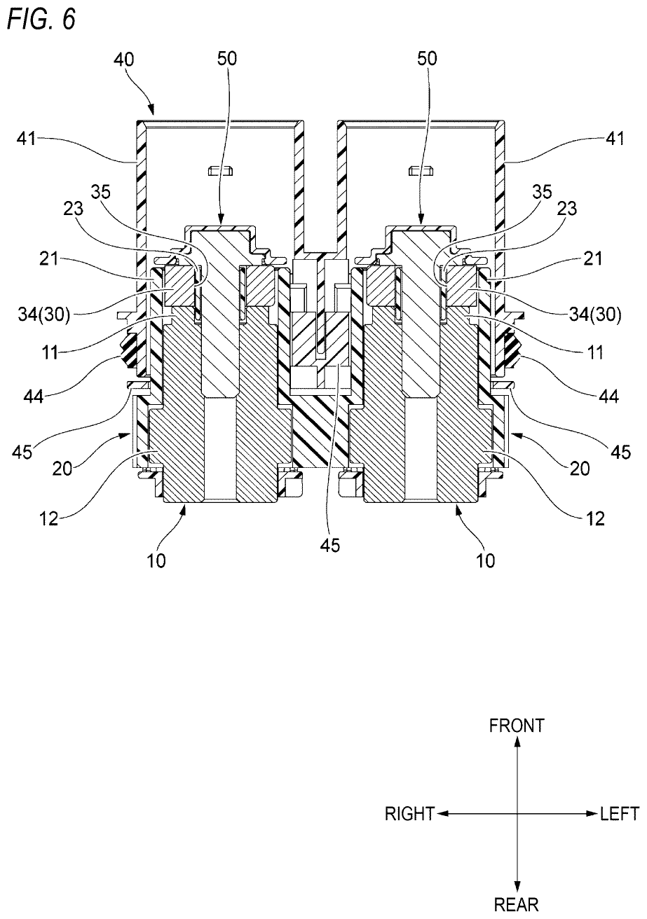

Hereinafter, a terminal connection structure 3 according to an embodiment of the present disclosure will be described with reference to the drawings. The terminal connection structure 3 shown in FIGS. 1 and 2 has a function of electrically connecting a first terminal 10 (see FIG. 6) in a first connector 1 and a second terminal 30 in a second connector 2 by fitting the first connector 1 and the second connector 2.

Hereinafter, for convenience of description, “front”, “rear”, “upper”, “lower”, “left”, “right”, a “front-rear direction”, an “upper-lower direction”, and a “left-right direction” are defined as shown in FIG. 1 and the like. The “front-rear direction”, the “upper-lower direction”, and the “left-right direction” are orthogonal to one another. The front-rear direction coincides with the fitting direction of the first connector 1 and the second connector 2.

As shown in FIGS. 2, 6, and the like, the first connector 1 mainly includes a first terminal 10 and a first housing 20 that houses the first terminal 10. As shown in FIG. 2 and the like, the second connector 2 mainly includes a second terminal 30 and a second housing 40 that houses the second terminal 30. Hereinafter, the configurations of the members that constitute the first connector 1 will be described in order.

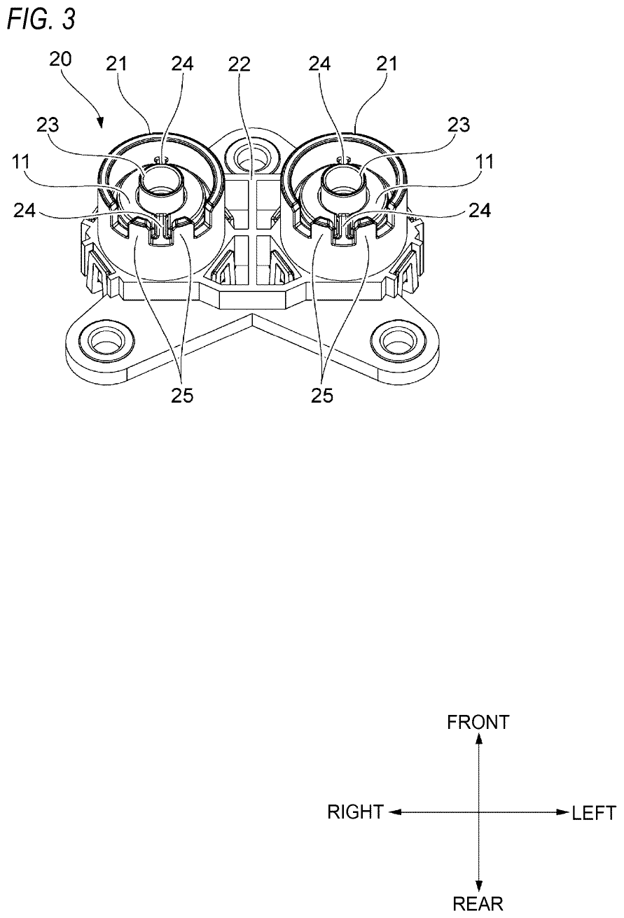

First, the first terminal 10 will be described. As shown in FIG. 6, the first terminal 10 made of metal has a substantially cylindrical shape extending in the front-rear direction as a whole. A cylindrical inner wall surface defining the hollow portion of the first terminal 10 is provided with a female screw (not shown) over the front-rear direction. On the front end surface (the annular flat surface) of the first terminal 10, a protrusion 11 having a substantially annular shape when viewed from the front is integrally provided so as to protrude forward (see also FIG. 3). However, in each of the protruding end surfaces (the front end surfaces) of the upper end portion and the lower end portion of the protrusion 11, a groove (not shown) recessed rearward and extending in the radial direction (the upper-lower direction) of the protrusion 11 is formed so as to divide the protrusion 11 into left and right halves. A pair of upper and lower bridge portions 24 of the first housing 20 to be described later are accommodated in the pair of upper and lower grooves of the protrusion 11. A protruding portion 12 protruding radially outward is integrally formed on the outer periphery near the rear end portion of the first terminal 10. The outer periphery of the protruding portion 12 has, for example, a regular hexagonal shape when viewed from the front-rear direction. Here, the protrusion 11 corresponds to a “first contact portion” according to the present disclosure.

Next, the first housing 20 will be described. The first housing 20 is a resin molded product, and integrally includes a pair of left and right tubular portions 21 and a coupling body portion 22 that couples the rear end portions of the pair of left and right tubular portions 21 to each other, as shown in FIGS. 2, 3, and the like. The pair of left and right tubular portions 21 extend in the front-rear direction so as to be aligned with a gap in the left-right direction. The tubular portion 21 has a substantially cylindrical shape, and is open on each of the front end side and the rear end side. As shown in FIGS. 2, 3, and 6, a small-diameter tubular portion 23 extending in the front-rear direction is supported in the hollow portion of the front end portion of the tubular portion 21 by the pair of upper and lower bridge portions 24 (see FIG. 3) extending in the upper-lower direction so as to be located coaxially with the tubular portion 21. More specifically, the upper end portion of the rear end portion of the small-diameter tubular portion 23 is connected to the inner wall surface of the tubular portion 21 by the upper bridge portion 24, and the lower end portion of the rear end portion of the small-diameter tubular portion 23 is connected to the inner wall surface of the tubular portion 21 by the lower bridge portion 24. The small-diameter tubular portion 23 has a cylindrical shape having a smaller diameter than the tubular portion 21, and is open on each of the front end side and the rear end side. The front end position of the small-diameter tubular portion 23 and the front end position of the tubular portion 21 substantially coincide with each other in the front-rear direction (see FIG. 6). As shown in FIGS. 2 and 3, in the lower region of the front end edge portion of the tubular portion 21, notches recessed rearward are formed at three positions at intervals in the circumferential direction of the tubular portion 21, so that protruding portions 25 protruding forward are formed at two positions between the three notches. Here, the opening at the front end edge portion of the tubular portion 21 corresponds to a “first opening” according to the present disclosure, and the protruding portion 25 corresponds to a “protruding portion” according to the present disclosure.

In order to assemble the first connector 1, the first terminal 10 is inserted and accommodated into each of the pair of left and right tubular portions 21 of the first housing 20 from the rear side. In a state in which housing of the first terminal 10 in the first housing 20 is completed, as shown in FIG. 6, the pair of upper and lower bridge portions 24 of the tubular portion 21 of the first housing 20 are accommodated in the pair of upper and lower grooves of the protrusion 11 of the first terminal 10, the substantially annular protrusion 11 covers the outer periphery of the rear end edge portion of the small-diameter tubular portion 23, and the front end surface (the flat surface) of the protrusion 11 is located on the front side with respect to the pair of upper and lower bridge portions 24. Further, the relative rotation of the first terminal 10 about the axis with respect to the tubular portion 21 is restricted by the engagement between the protruding portion 12 of the first terminal 10 and the inner wall surface of the tubular portion 21. In the present example, after the accommodation of the first terminal 10 in each of the pair of left and right tubular portions 21 of the first housing 20 is completed, a holder 26 made of resin is further mounted on the rear end edge portions of the pair of left and right tubular portions 21 (see FIGS. 2, 5, and 6). The holder 26 functions to prevent the first terminal 10 from coming off rearward from the first housing 20. According to the above, the assembly of the first connector 1 is completed, and the first connector 1 shown in FIG. 2 is obtained. An electric wire (for example, a power supply line) (not shown) is electrically connected, by fastening or the like, to each of the rear end portions of the pair of left and right first terminals 10 of the assembled first connector 1.

In the assembled first connector 1, as shown in FIGS. 3 and 6, the front end surface of the protrusion 11 of the first terminal 10 is exposed to the outside through the opening in the front end edge portion of the tubular portion 21 of the first housing 20. The front end surface of the protrusion 11 of the first terminal 10 is located behind the front ends of the tubular portion 21 and the small-diameter tubular portion 23, and is surrounded by the tubular portion 21 and the small-diameter tubular portion 23. Therefore, the operator can be prevented from erroneously touching the front end surface of the protrusion 11 of the first terminal 10. The configuration of the first connector 1 has been described above. Next, the configurations of the members that constitute the second connector 2 will be described in order.

First, the second terminal 30 will be described. As shown in FIG. 2, the second terminal 30 includes a metal bus bar 31 having an elongated flat plate shape with a rectangular cross section, and an insulating sheath 32 covering the outer periphery of the bus bar 31. At one end portion (the upper end portion) of the bus bar 31, the insulating sheath 32 is removed by so-called terminal processing. Two through holes 33 penetrating the bus bar 31 in the plate thickness direction (the front-rear direction) are formed at the one end portion of the bus bar 31 so as to correspond to the two protruding portions 25 of the tubular portion 21 of the first housing 20. The protrusion 34 having a substantially circular flat plate shape when viewed from the plate thickness direction extends from the one end portion of the bus bar 31. A through hole 35 penetrating in the plate thickness direction is formed in the central portion of the protrusion 34 so as to correspond to the small-diameter tubular portion 23 of the first housing 20 (such that the small-diameter tubular portion 23 can be inserted therethrough). Here, the protrusion 34 corresponds to a “second contact portion” according to the present disclosure, and the through hole 33 corresponds to an “inserted portion” according to the present disclosure.

Next, the second housing 40 will be described. The second housing 40 is a resin molded product, and integrally includes, as shown in FIG. 2 and the like, a pair of left and right tubular portions 41, a coupling body portion 42 that couples the rear end portions of the pair of left and right tubular portions 41, and a pair of left and right terminal accommodating tubular portions 43 that extend downward from the front-rear direction positions adjacent to the front side of the coupling body portion 42 in the pair of left and right tubular portions 41. The pair of left and right tubular portions 41 correspond to the pair of left and right tubular portions 21 of the first housing 20 and extend in the front-rear direction so as to be aligned with a gap in the left-right direction. The tubular portion 41 has a substantially cylindrical shape, and is open on each of the front end side and the rear end side. The coupling body portion 42 has an outer peripheral shape of an ellipse elongated in the left-right direction when viewed from the front-rear direction. The terminal accommodating tubular portion 43 has a rectangular tubular shape such that the bus bar 31 of the second terminal 30 can be inserted therein, and the hollow portion of the terminal accommodating tubular portion 43 and the hollow portion of the tubular portion 41 communicate with each other. The lower end side of the terminal accommodating tubular portion 43 is open. An annular packing 44 made of rubber is mounted on the outer periphery of the coupling body portion 42. A holder 45 made of resin is mounted on the rear end side of the coupling body portion 42 in order to prevent the packing 44 from falling off. A holder 46 made of resin is mounted on the lower end edge portion of the terminal accommodating tubular portion 43 (see FIGS. 2, 5, and 6). The holder 46 functions to prevent rattling of the second terminal 30 extending from the lower end edge of the terminal accommodating tubular portion 43. Here, the opening of the rear end edge portion of the tubular portion 41 corresponds to a “second opening” according to the present disclosure.

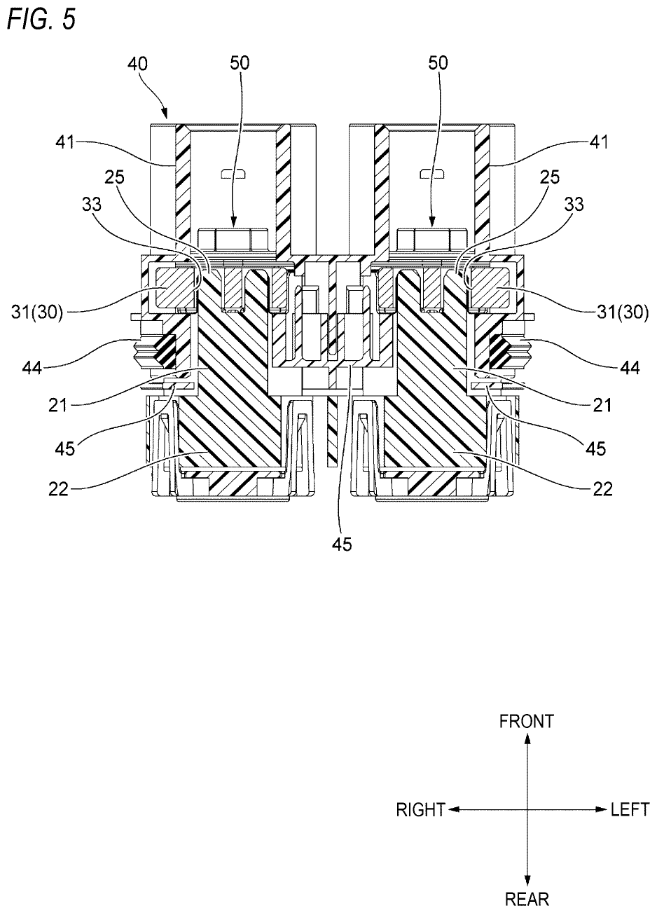

In order to assemble the second connector 2, the second terminal 30 is inserted and accommodated into each of the pair of left and right terminal accommodating tubular portions 43 of the second housing 40 from below. In a state in which housing of the second terminal 30 in the second housing 40 is completed, the protrusion 34 and the two through holes 33 of the second terminal 30 are located in the hollow portion of the tubular portion 41 of the second housing 40, and accordingly are exposed to the outside through the opening of the rear end edge portion of the tubular portion 41. Next, as shown in FIG. 6, the first housing 20 of the first connector 1 is fitted to the second housing 40 from the rear side. This fitting progresses such that the tubular portion 21 is inserted into the tubular portion 41, the protrusion 34 is inserted into the tubular portion 21, the small-diameter tubular portion 23 is inserted into the through hole 35, and the two protruding portions 25 are inserted into the two through holes 33 (see FIG. 5). When the fitting is completed, the front end surface of the protrusion 11 of the first terminal 10 and the rear end surface of the protrusion 34 of the second terminal 30 come into contact with each other (see FIG. 6). Next, for each of the pair of left and right first terminals 10, the male screw portion of a metal bolt 50 is inserted into the small-diameter tubular portion 23 located in the through hole 35 of the protrusion 34 and screwed into the female screw of the hollow portion of the first terminal 10 with a predetermined torque. Accordingly, the protrusion 34 of the second terminal 30 is pressed and sandwiched between the protrusion 11 of the first terminal 10 and the seat surface portion of the bolt 50, so that the first terminal 10 and the second terminal 30 are fastened and fixed in a state in which the front end surface of the protrusion 11 and the rear end surface of the protrusion 34 are in direct pressing contact with each other. According to the above, the terminal connection structure 3 shown in FIG. 1 is completed simultaneously with the completion of the assembly of the second connector 2.

### Operations and Effects

As described above, according to the terminal connection structure 3 in the present embodiment, when the first connector 1 and the second connector 2 are fitted to each other, the first terminal 10 and the second terminal 30 are fastened and electrically connected by the fastener (the bolt 50) in a state in which the protruding portion 25 of the first connector 1 is inserted into the inserted portion (the through hole 33) of the second terminal 30 and the first contact portion (the protrusion 11) of the first terminal 10 and the second contact portion (the protrusion 34) of the second terminal 30 are in contact with each other. Further, since the first terminal 10 is accommodated in the first connector 1 such that the first contact portion 11 of the first terminal 10 is exposed from the first opening, it is possible to prevent an operator from coming into contact with a portion other than the first contact portion 11. Therefore, the terminal connection structure 3 according to the present embodiment can be reduced in thickness and size while preventing erroneous touch by an operator.

Further, according to the terminal connection structure 3 in the present embodiment, the first opening of the first connector 1 includes the tubular portion 21, and the protruding portion 25 is provided at the extending end of the tubular portion 21. Accordingly, the first connector 1 can be further reduced in size by integrating the tubular portion 21 constituting the first opening and the protruding portion 25.

Further, according to the terminal connection structure 3 in the present embodiment, the first terminal 10 has a tubular shape, the protrusion 11 of the first terminal 10 is used as the first contact portion, and the fastener (that is, the bolt 50) is screwed into the hollow portion of the first terminal 10. Accordingly, the first connector 1 can be further reduced in size as compared with a case in which a nut is provided as a separate member.

### Other Embodiments

The present disclosure is not limited to the embodiment described above and various modifications can be adopted within the scope of the present disclosure. For example, the present disclosure is not limited to the embodiment described above, and modifications, improvements, and the like can be appropriately made. In addition, the materials, shapes, sizes, numbers, arrangement positions, and the like of the components in the embodiment described above are freely selected and are not limited as long as the present disclosure can be implemented.

Here, the features of the embodiment of the terminal connection structure 3 according to the present disclosure described above are briefly summarized and listed in the following [1] to [3].
[1] A terminal connection structure (3) including:
a first connector (1) including a first terminal (10);
a second connector (2) including a second terminal (30) electrically connected to the first terminal (10); and
a fastener (50) configured to fasten the first terminal (10) and the second terminal (30),
in which the first terminal (10) and the second terminal (30) are electrically connected to each other,
in which the first connector (1) includes a first opening (21) configured to expose a first contact portion (11) of the first terminal (10), and a protruding portion (25) protruding toward the second connector (2),
in which the second connector (2) includes a second opening (41) configured to expose a second contact portion (34) of the second terminal (30) and an inserted portion (33) of the second terminal (30), the inserted portion (33) having a shape into which the protruding portion (25) is to be inserted, and
in which the fastener (50) fastens the first terminal (10) and the second terminal (30) in a state in which the first connector (1) and the second connector (2) are fitted to each other, in which the protruding portion (25) is inserted into the inserted portion (33), and in which the first contact portion (11) and the second contact portion (34) are in contact with each other.

According to the terminal connection structure having the configuration in [1] described above, when the first connector and the second connector are fitted to each other, the first terminal and the second terminal are fastened and electrically connected by the fastener in a state in which the protruding portion of the first connector is inserted into the inserted portion of the second terminal and the first contact portion of the first terminal and the second contact portion of the second terminal are in contact with each other. That is, the first terminal and the second terminal are connected without requiring a relay terminal or the like as in the connection structure in the related art. Further, the first terminal is accommodated in the first connector such that the first contact portion of the first terminal is exposed from the first opening, so that it is possible to prevent an operator from coming into contact with a portion other than the first contact portion. Therefore, the terminal connection structure having the present configuration can be reduced in thickness and size while preventing erroneous touch by an operator.
[2] In the terminal connection structure (3) according to [1] described above,
the first opening includes a tubular wall (21) surrounding the first contact portion (11) and extending in a fitting direction of the first connector (1) and the second connector (2), and
the tubular wall (21) includes the protruding portion (25) at an extending end of the tubular wall (21).

According to the terminal connection structure having the configuration in [2] described above, the first opening of the first connector includes the tubular wall, and the protruding portion is provided at the extending end of the tubular wall. In this way, the first connector can be further reduced in size by integrating the tubular portion constituting the first opening and the protruding portion.
[3] In the terminal connection structure (3) according to [1] described above,
the first terminal (10) has a tubular shape, and a tubular end portion (11) of the first terminal (10) is the first contact portion,
the second terminal (30) has a plate shape, and a plate surface portion (34) of the second terminal (30) is the second contact portion, and
the fastener is a bolt (50) and is screwed into a hollow portion of the first terminal (10) through the second terminal (30), thereby fastening the first terminal (10) and the second terminal (30) in a state in which the first contact portion (11) and the second contact portion (34) are in contact with each other.

According to the terminal connection structure having the configuration in [3] described above, the first terminal has a tubular shape, the tubular end portion of the first terminal is used as the first contact portion, and the fastener (that is, the bolt) is screwed into the hollow portion of the first terminal. Accordingly, the first connector can be further reduced in size as compared with a case in which a nut is provided as a separate member.

1. A terminal connection structure comprising:
a first connector including a first terminal;
a second connector including a second terminal electrically connected to the first terminal; and
a fastener configured to fasten the first terminal and the second terminal,
wherein the first terminal and the second terminal are electrically connected to each other,
wherein the first connector includes a first opening configured to expose a first contact portion of the first terminal, and a protruding portion protruding toward the second connector,
wherein the second connector includes a second opening configured to expose a second contact portion of the second terminal and an inserted portion of the second terminal, the inserted portion having a shape into which the protruding portion is to be inserted, and
wherein the fastener fastens the first terminal and the second terminal in a state in which the first connector and the second connector are fitted to each other, in which the protruding portion is inserted into the inserted portion, and in which the first contact portion and the second contact portion are in contact with each other.

2. The terminal connection structure according to claim 1,
wherein the first opening includes a tubular wall surrounding the first contact portion and extending in a fitting direction of the first connector and the second connector, and
wherein the tubular wall includes the protruding portion at an extending end of the tubular wall.

3. The terminal connection structure according to claim 1,
wherein the first terminal has a tubular shape, and a tubular end portion of the first terminal is the first contact portion,
wherein the second terminal has a plate shape, and a plate surface portion of the second terminal is the second contact portion, and
wherein the fastener is a bolt and is screwed into a hollow portion of the first terminal through the second terminal, thereby fastening the first terminal and the second terminal in a state in which the first contact portion and the second contact portion are in contact with each other.
